(19) United States
(12) Patent Application Publication
(10) Pub. No.: US 2019/0294548 A1
(43) Pub. Date: Sep. 26, 2019

(54) PREFETCH MODULE FOR HIGH THROUGHPUT MEMORY TRANSFERS

(71) Applicant: MACOM Technology Solutions Holdings, Inc., Lowell, MA (US)

(72) Inventors: Waseem Kraipak, Nagar Pune (IN); Thomas Edward Sellinger, Andover, MA (US); Christopher Leo Collins, Carp (CA)

(21) Appl. No.: 15/927,638

(22) Filed: Mar. 21, 2018

(51) Int. Cl. G06F 12/0862; G06F 13/16

(52) U.S. Cl. CPC G06F 12/0862; G06F 13/1673; G06F 2212/1021; G06F 2213/16; G06F 2212/20; G06F 2212/602; G06F 2212/1024

(57) ABSTRACT

Aspects of a prefetch module for high throughput memory transfers is described. Data stored in a row buffer of a memory device can be quickly transferred over a serial link to a prefetch buffer. In one example, a number of respective serial links can be used to transfer the data stored in several row buffers of respective memory devices to the prefetch buffer. In the prefetch buffer, all the data from the memory devices is stored in a data cache. Once the data is cached at the prefetch buffer, a memory controller can access it more quickly in any suitable way. As compared to conventional approaches, the embodiments can be relied upon to avoid a significant amount of latency in memory read and write operations with memory modules.

### BACKGROUND

Double data rate (DDR) synchronous dynamic random access memory (SDRAM) is a type of integrated circuit memory device used in computing devices. As compared to single data rate, the DDR interface allows for higher transfer rates through timing control of the data and clock signals. The interface transfers data on both the rising and falling edges of the clock signal to double data bandwidth without an increase in clock frequency.

A number of DDR SDRAM memory chips can be mounted on a single dual in-line memory module (DIMM). A DIMM can be designed having two or more independent sets of memory chips, each connected to the same address and data buses of the DIMM. Each set of memory chips connected to the same address and data buses is called a rank. Only one rank can be accessed at a time on the DIMM because all the ranks share the same buses. A rank can be activated by its corresponding chip select (CS) signal, and all other ranks should be deactivated at that time.

### BRIEF DESCRIPTION OF THE DRAWINGS

Aspects of the present disclosure can be better understood with reference to the following drawings. It is noted that the elements in the drawings are not necessarily to scale, with emphasis instead being placed upon clearly illustrating the principles of the embodiments. In the drawings, like reference numerals designate like or corresponding, but not necessarily the same, elements throughout the several views.

FIG. 1 illustrates an example system including a system on chip integrated circuit device and memory module according to various embodiments described herein.

FIG. 2 illustrates an example system including a prefetch module between the system on chip device and the memory module shown in FIG. 1 according to various embodiments described herein.

FIG. 3 further illustrates the example system shown in FIG. 2 according to various embodiments described herein.

FIG. 4A illustrates an example of the prefetch module located on the memory module shown in FIG. 3 according to various embodiments described herein.

FIG. 4B illustrates an example of the prefetch module located on the system on chip device shown in FIG. 3 according to various embodiments described herein.

FIG. 5A illustrates example components of the prefetch module according to various embodiments described herein.

FIG. 5B further illustrates example components of the prefetch module according to various embodiments described herein.

FIG. 6 illustrates an example prefetch process performed by a prefetch module according to various embodiments described herein.

### DETAILED DESCRIPTION

The read latency of random access memory (RAM) is a bottleneck in many modern computing devices and systems. Similar to other types of RAM devices, the read latency of DDR SDRAM can present a bottleneck in computing devices and systems. DDR SDRAM has also been adopted for use in devices including system on a chip (SOC) integrated circuit devices, and the read latency of DDR SDRAM presents a similar bottleneck to the processing capabilities of SOC devices. As an example of the types of read latencies for RAM devices, the read latency of DDR SDRAM includes column access strobe latency, row column delay latency, row precharge time latency, and row active time latency.

DRAM memory cells are arranged in a rectangular array. Each row of the array can be selected by a horizontal word line. Activating a given row activates transistors present in that row, connecting the storage capacitor of each memory cell in that row to a corresponding vertical bit line. Each bit line is connected to a sense amplifier that amplifies a voltage stored in the storage capacitor. The amplified signal is output as data from the DRAM memory array and used to refresh the memory cell.

Thus, to access data stored in the memory array of a DRAM device, it is first necessary to access a row of storage capacitors and couple them to the sense amplifiers. The row access strobe (RAS) latency is the delay between when a row address and row address strobe signal (e.g., an activate command) are presented to the memory device and when the voltages stored in a row of the storage capacitors is coupled to and sensed by the sense amplifiers. Once a row is active, columns in the row can be accessed for read or write. The column access strobe (CAS) latency is the delay between when a column address and column address strobe signal are presented to the memory device and when the corresponding data is available for read. For a completely unknown memory access (e.g., a random access), the relevant latency is the time needed to close any open row, plus the time needed to open the desired row, followed by the CAS latency to read data from columns in the open row. Due to spatial locality, it is common to access several columns in the same row. In that case, CAS latency is the primary delay between inter-column read operations on the same active row.

Row access involves sensing the voltages stored in a row of storage capacitors, which is the slowest phase of a memory read operation. Once a row has been sensed by the sense amplifiers, subsequent column accesses to the row are relatively faster, as the sense amplifiers can also act as a row buffer of latches. The row access may take 50 ns, for example, depending on the speed of the DRAM, while column accesses within an open row may take 10 ns each. Thus, among other delays, RAS latency exists between row accesses, and CAS latency exists between subsequent column accesses.

As an example, the sense amplifiers and row buffer of a 1 Gbit DDR device may be 2,048 bits wide. Thus, 2,048 voltages from 2,048 different storage capacitors are fed, sensed, and latched into 2,048 respective sense amplifiers during a row access. Thus, for a memory device having a 2,048 bit wide row buffer and an 8 bit wide (i.e., one byte wide) output data bus, an entire row can be accessed through 256 different column accesses (i.e., 2048 bit row/8 bit wide output data bus) provided that no intervening accesses occur to other rows.

When eight different memory devices each having an 8 bit wide output data bus are mounted on the same DIMM, then 8 bytes of data can be retrieved from the devices during a single column access of the devices. The 8 bytes of data can be forwarded over a 64 bit wide bus on the DIMM, for example, to a memory controller. In each subsequent column access, another 8 bytes of data can be transferred over the 64 bit wide bus until the entire row of data stored in each row buffer of the memory devices has been accessed. Thus, despite the fact that each of the eight memory devices has buffered and is ready to output 2048 bits of data in the row buffer after a row access, the data is transferred in a number of 64 bit wide chunks during a number of column reads.

According to aspects of the embodiments described herein, all of the data stored in a row buffer of a memory device during a row access can be quickly transferred over a serial link to a prefetch buffer. A number of respective serial links can be used to transfer the data stored in the row buffers of a number of different memory devices to the prefetch buffer in a similar way. In the prefetch buffer, all the data from the memory devices is stored in a data cache. Once the data is cached at the prefetch buffer, a memory controller can access it more quickly in any suitable way, such as in 64 byte cache line chunks. As compared to conventional approaches, the embodiments described herein can be relied upon to avoid a significant amount of latency in memory read and write operations with memory modules. Other advantages of the embodiments are described below.

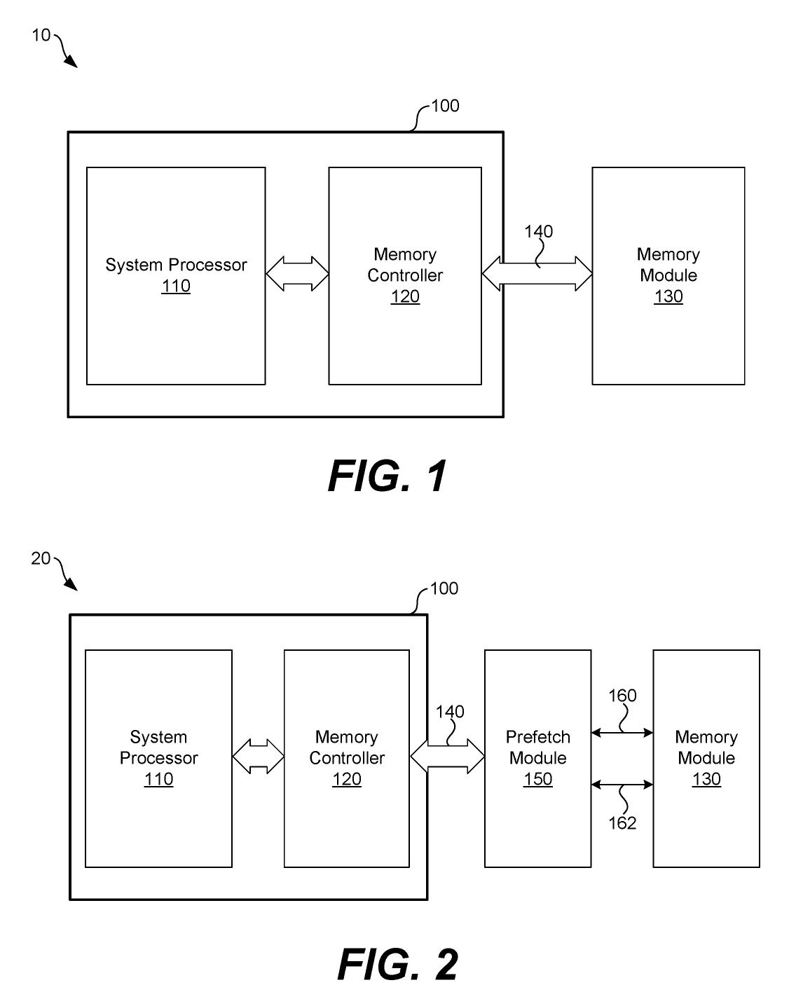

Turning to the drawings, FIG. 1 illustrates an example system 10 including a system on chip (SOC) 100 and memory module 130 according to various embodiments described herein. As shown, the SOC 100 includes a system processor 110 and a memory controller 120, among other components. The SOC 100 is communicatively coupled to the memory module 130 by the local interface 140, which can include an address bus, data bus, and control signals.

The SOC 100 can be embodied as an integrated circuit device that includes various components of a computing system. For example, in addition to the system processor 110 and the memory controller 120, the SOC 100 can include other digital, analog, mixed-signal, and/or radio-frequency (RF) circuitry, such as memory blocks, phase-locked loops, timers, digital and/or analog interfaces, voltage regulators, power management circuitry, and other circuitry. The components can be formed together on a single substrate or formed on different substrates but packaged together in the same semiconductor package of the SOC 100. The components can also be tailored for a particular use, such as for low power applications, mobile devices, embedded systems, or other purposes.

The system processor 110 can be embodied as any suitable microcontroller, general purpose processor, microprocessor, digital signal processor, or variant thereof. The memory controller 120 can be embodied as any suitable memory controller configured to access the memory module 130 through the local interface 140. The primary purpose of the memory controller 120 is to retrieve data and executable instructions that are stored on the memory module 130 for processing by the system processor 110.

In one example, the memory module 130 can be embodied as one or more DIMM memory modules including a number of DDR SDRAM memory devices mounted thereon. In that case, the memory controller 120 of the SOC 100 can be embodied as a DDR Physical (PHY) Interface (DFI). DFI is DDR interface protocol that defines connectivity between a memory controller (MC), such the memory controller 120, and an interface, such as the local interface 140, for data transfers to and from DDR memory devices. The protocol defines the types and timing parameters of the signals relied upon to transfer control information and data to and from DDR memory devices. DFI is used in many different types of devices, including desktop and laptop computers, gaming consoles, set-top boxes, smart phones, and other devices. According to the DFI interface protocol, a DDR memory device can be accessed by first providing a row address, then a column address, to the device. After a row of the memory array in the memory device has been opened, the column address can be incremented in a burst mode to access data in the row.

The system 10 can suffer from a processing bottleneck due in part to the RAS and CAS latencies of the memory devices on the memory module 130. To overcome that processing bottleneck, the embodiments described herein rely upon a new way of transferring data between the memory module 130 and the SOC 100. As described in further detail below, one or more high speed serial interfaces are used to transfer larger chunks of data between the memory devices on the memory module 130 and the SOC 100. For example, when a row access occurs on a memory device on memory module 130, all the data stored in the row buffer of that memory device, which may be 2 Kbits of data, can be transferred over a high speed serial interface to a prefetch buffer between the SOC 100 and the memory module 130. The data can be cached in a data cache on the prefetch buffer and accessed by the memory controller 120 in any suitable way without the same level of RAS and CAS latencies as seen with conventional DDR access techniques, mitigating the processing bottlenecks in the system 10.

Before turning to some particular examples of the embodiments, it is noted that the embodiments are not limited to use with any particular types of memory interface protocols, memory controllers, memory devices, or other constraints. Instead, the use of high speed serial links to expedite the transfer of data between memory devices and processing circuitry, as described herein, can be applied for use with any suitable types of memory controllers and memory devices.

FIG. 2 illustrates an example system 20 including a prefetch module 150 coupled between the SOC 100 and the memory module 130 shown in FIG. 1. As shown, the prefetch module 150 is communicatively coupled between the memory controller 120 of the SOC 100 and the memory module 130. The memory controller 120 is communicatively coupled to the prefetch module 150 by the local interface 140, and the prefetch module 150 is communicatively coupled to the memory module 130 by the control interface 160 and the high speed serial link 162. The control interface 160 can include signal lines to carry addressing signals (e.g., row and column addresses) and control signals (e.g., clock enable (CKE), chip select (CS), data mask (DQM), RAS, CAS, write enable (WE), bank selection, etc.) among others. The high speed serial link 162 can be embodied as any number of high speed serial links. Each high speed serial link can be embodied as a one wire, two wire (e.g., differential), three wire, or other serial link, using any suitable high speed serial link protocol(s).

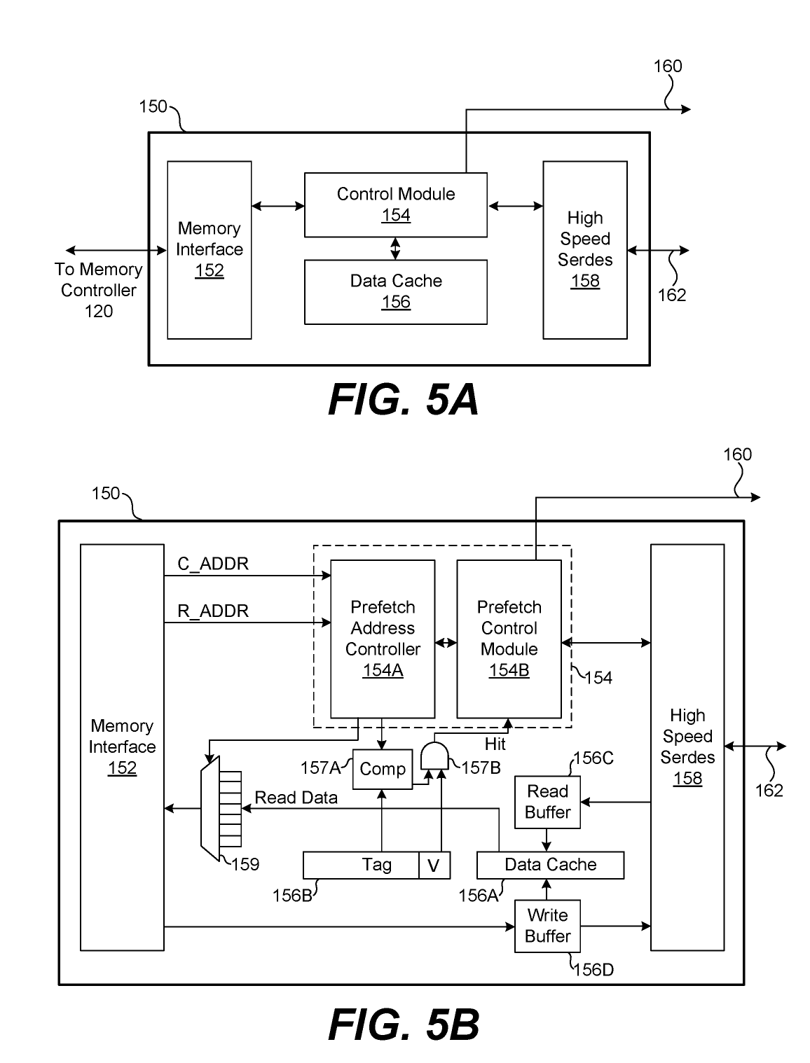

As described in further detail below with reference to FIGS. 5A and 5B, the prefetch module 150 can include a serializer/deserializer (serdes) configured to serialize data for transmission over the high speed serial link 162 and to deserialize data received over the high speed serial link 162. The prefetch module 150 can also include a data cache configured to cache data received over the high speed serial link 162, and a tag memory configured to store tag addresses and validity bits associated data stored in the data cache. The prefetch module 150 also includes a prefetch control module configured to coordinate the exchange of data between the memory controller 120 and the memory module 130 based on interface signals defined by an interface protocol of the memory controller 120.

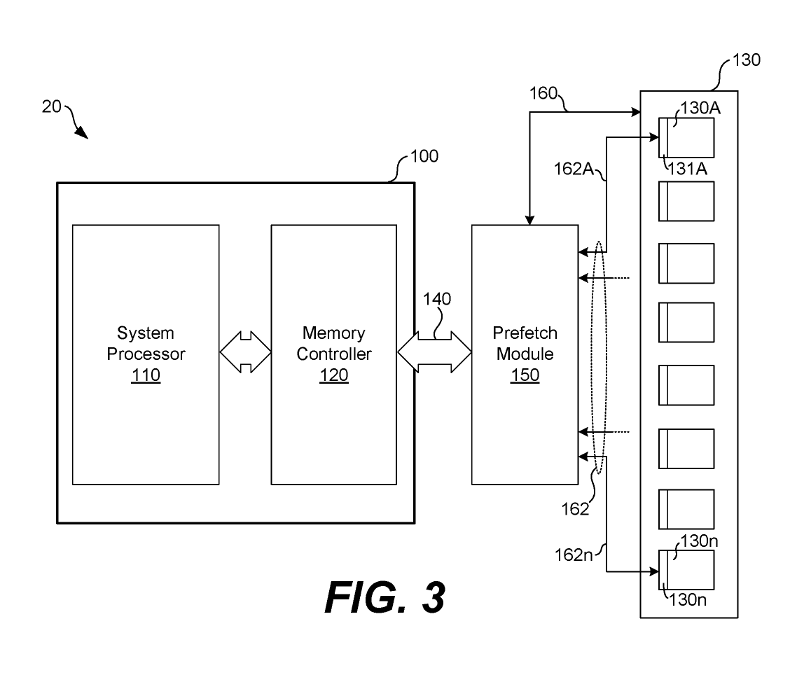

FIG. 3 further illustrates the example system 20 shown in FIG. 2. In FIG. 3, the high speed serial link 162 is shown as a number of different high speed serial links 162A-n coupled, respectively, to individual ones of the memory devices 130A-130n. According to one aspect of the embodiments, each of the memory devices 130A-130n can include a respective serdes 131A-131n. The serdes 131A, for example, can replace (or supplement) the 8 bit wide output data bus of the memory device 130A.

Each of the memory devices 130A-130n can be embodied as a DDR memory device having a 2,048 bit wide row buffer, for example. When a row of data is accessed and held in the row buffer of the memory device 130A, the serdes 131A can be used to serially transfer the data from the row buffer to the prefetch module 150 by the high speed serial link 162A. Data can be transferred from the row buffers of each of the memory devices 130A-n to the prefetch module 150 using respective ones of the serdes 131A-131n. This high speed data transfer can be used for both data read and data write operations.

Thus, rather than accessing and transferring columns of data from the row buffers of the memory devices 130A-n in a number of 8 bits chunks over an 8 bit wide data bus, with a CAS latency between each column access, all the data from the row buffers can be transferred over the high speed serial links 162A-162n according to the same high speed serial data transfer operation. If each of the memory devices 130A-130n includes a row buffer of 2 Kbits, the prefetch buffer can receive a total of 16 Kbits of data from the memory devices 130A-130n in one high speed data transfer operation based on a single row access. The 16 Kbits of data can be cached in the prefetch module 150 and accessed by the memory controller 120 in faster ways than would have been otherwise possible.

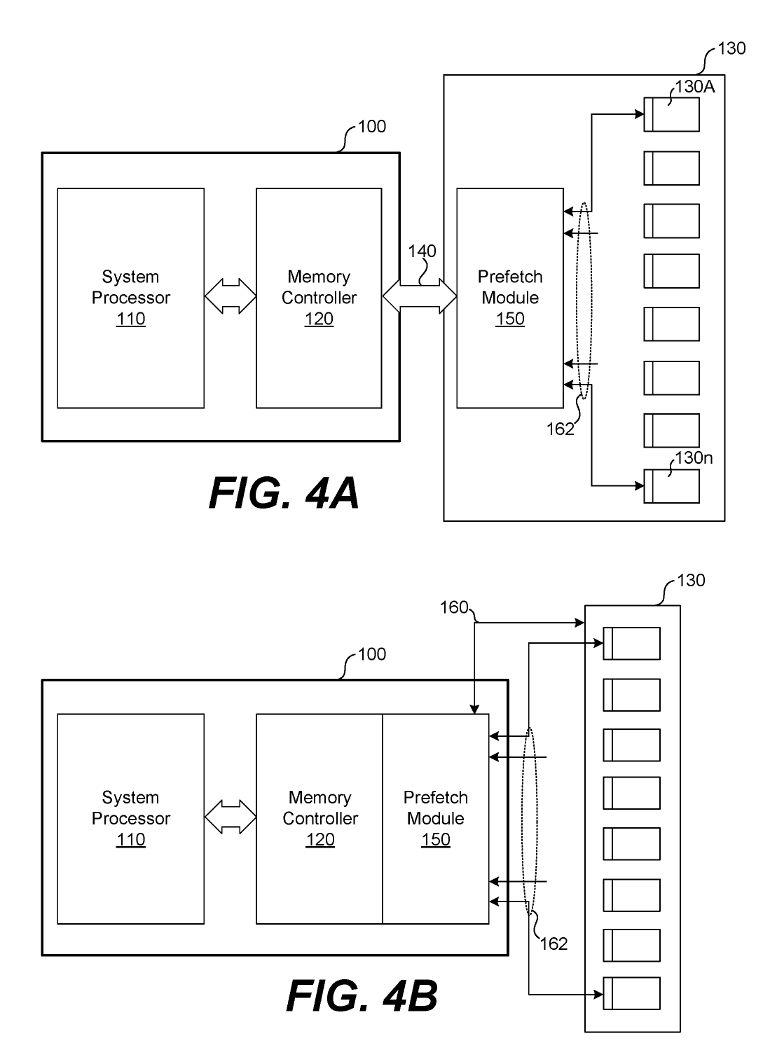

FIG. 4A illustrates an example of the prefetch module 150 located on the memory module 130, and FIG. 4B illustrates an example of the prefetch module 150 located on the SOC 100. FIGS. 4A and 4B are presented to convey how the prefetch module 150 can be integrated or reside with other components in a system.

In the example shown in FIG. 4A, the primary operation of the prefetch module 150 is still similar to that outlined above and described in further detail below. From a system design standpoint, however, any changes to the system board to which the SOC 100 and the memory module 130 are mounted can be eliminated or minimized. The local interface 140, which can include an address bus, data bus, and control signals, can be the same as that shown in FIG. 1. Rather than altering the form of the local interface 140, the memory controller 120 can be updated to use the local interface 140 in a new, faster way.

For example, the memory controller 120 can request data from the memory module 130 over the local interface 140. This request can be received by the prefetch module 150. If the requested data is not already cached by the prefetch module 150, the prefetch module 150 can generate an activate command to open a row of data in each of the memory devices 130A-130n on the memory module 130. The data in the row buffers of the memory devices 130A-130n can then be transferred over the high speed serial link 162 to the prefetch module 150 where it is stored in a data cache. The prefetch module 150 can, in turn, return the data requested by the memory module 130 over the local interface 140. From that point, the memory controller 120 can continue to request data from the memory module 130 without the need to wait for CAS latencies between column accesses. Instead, data can be transferred from the prefetch module 150 to the memory controller 120 in any suitable way without experiencing as much latency between column accesses, such as by back-to-back burst mode accesses without intervening CAS latencies.

In the example shown in FIG. 4B, the primary operation of the prefetch module 150 is also similar to that outlined above and described in further detail below. From a system design standpoint, however, the system board to which the SOC 100 and the memory module 130 are mounted can be changed as compared to FIG. 4A. The local interface 140 can be omitted as shown. The 64 bit wide data bus of the local interface 140 can be replaced by the high speed serial link 162 and the control interface 160. Because the 64 bit wide data bus of the local interface 140 is replaced by a high speed serial link 162 including, for example, 8 differential pair signal pathways, the number of signal pathways can be reduced by 48.

In the arrangement shown in FIG. 4B, the memory controller 120 can directly communicate with the prefetch module 150 using the DDR protocol defined by the DFI standard, without the local interface 140 between them. Here, all requests to read or write data are also received by the prefetch module 150 from the memory controller 120. If a request for data is not already cached by the prefetch module 150, the prefetch module 150 can generate an activate command to open a row of data in each of the memory devices 130A-130n on the memory module 130. The data in the row buffers of the memory devices 130A-130n can then be transferred over the high speed serial link 162 to the prefetch module 150 where it is stored in a data cache. The prefetch module 150 can, in turn, return the data requested to the memory module 130. In this case, data can be returned to the memory module 130 in other, more flexible ways, because the local interface 140 has been replaced. As one example described in further detail below with reference to FIG. 5B, the prefetch module 150 can return data to the memory controller 120 in chunks of 64 bytes or other, larger or smaller, chunks.

FIG. 5A illustrates example components of the prefetch module 150 according to various embodiments described herein. As shown, the prefetch module 150 includes a memory interface 152, a control module 154, a data cache 156, and a high speed serdes 158. The memory interface 152 can be embodied as an interface for memory access operations with the memory controller 120. The memory interface 152 can be configured to receive commands over a physical interface, such as the local interface 140, or other interfaces suitable for use with DFI. The memory interface 152 is not limited to use with the DFI protocol, however, as other memory protocols and interfaces can be used.

The control module 154 is configured to control the overall operations of the prefetch module 150. The operations of the control module 154 are described in further detail below with reference to FIG. 5B. The data cache 156 comprises a memory area to store data at an intermediate location between the memory controller 120 and the memory module 130. The data cache 156 can be formed to store any suitable amount of data. As one example, the data cache 156 can be large enough to store a multiple of the 16 Kbits of data received from the row buffers of each of the memory devices 130A-130n (FIG. 3). The high speed serdes 158 can be embodied as any suitable type of serializer/deserializer. The high speed serdes 158 can be configured to serialize data for transmission over the high speed serial link 162 and to deserialize data received over the high speed serial link 162.

FIG. 5B further illustrates components of the prefetch module 150. In addition to the memory interface 152 and the high speed serdes 158, the control module 154 is shown in FIG. 5B to include a prefetch address controller 154A and a prefetch control module 154B. The data cache 156 is shown to include the data cache 156A, the tag memory 156B, the read buffer 156C, and the write buffer 156D. An address comparator 157A and hit logic 157B are also shown.

As data is received over the high speed serdes 158 for a read operation from the memory module 130, it can be temporarily held in the read buffer 156C as it is being assimilated into the data cache 156A. Similarly, as data is received over the memory interface 152 from the system processor 110 for a write operation to the memory module 130, it can be temporarily held in the write buffer 156D as it is being assimilated into the data cache 156A.

The data cache 156A is configured to store (e.g., cache) data at an intermediate location between the memory controller 120 and the memory module 130. The size of the data cache 156A can vary among the embodiments based on relevant design and costs considerations. As one example, if the cache line size of the system processor 110 is 64 bytes, the data cache 156A can store and buffer multiple cache lines of data for the system processor 110.

The tag memory 156B is configured to store tag addresses and validity bits associated with chunks of data stored in the data cache 156A. When the data cache 156A is addressed with a tag address in the tag memory 156B, the data cache 156A can output a corresponding chunk of data to the multiplexer 159 over the “Read Data” signal path. As one example, a chunk of data stored in the data cache 156A can correspond in size to the total amount of data retrieved over the high speed serial link 162 from a row access of all the memory devices 130A-130n as described herein, although any suitable amount of data can be used as a chunk. If the chunk of data is the same as the total amount of data retrieved from a row access of all the memory devices 130A-130n, then each tag address stored in the tag memory 156B can also correspond to a different row address (e.g., “R_ADDR”) received by the memory interface 152 from the memory controller 120. In one example, the length of each tag address stored in the tag memory 156B can be the same as the length of each row address received from the memory controller 120 according to the DFI protocol, although the lengths can differ in some embodiments.

When a row address is received from the memory controller 120 by the prefetch module 150 for a read operation from the memory module 130, the prefetch address controller 154A is configured to compare the row address with a corresponding tag address in the tag memory 156B using the address comparator 157A. The output of the address comparator 157A, which may be a logic true or false signal depending upon whether the addresses match, is provided as a first input to the hit logic 157B. The validity bit associated with the tag address in the tag memory 156B is also provided as a second input to the hit logic 157B. If the addresses match and the validity bit associated with the tag address is also true, the hit logic 157B can output a logic true signal (e.g., a “hit”) to the prefetch control module 154B. In that context, the validity bit can be used to confirm whether or not the data cache 156A stores valid data for the row address received from the memory controller 120.

If the validity bit associated with the tag address is false, then the hit logic 157B can output a logic false signal to the prefetch control module 154B. In that case, there is no “hit,” meaning that the prefetch buffer 150 has not previously cached the data being requested at the row address received from the memory controller 120. The prefetch control module 154B is configured in this case to access the memory module 130 over the control interface 160. Particularly, the prefetch control module 154B will send the appropriate activate command to open a row in each of the memory arrays of the memory devices 130A-130n according to the row address received from the memory controller 120. The prefetch control module 154B is also configured to coordinate the operations of the high speed serdes 158 to receive the data stored in the row buffers of each of the memory devices 130A-130n over the high speed serial link 162 as a chunk of data. The chunk of data can be temporarily placed in the read buffer 156C and, in turn, cached into the data cache 156A at a corresponding tag address stored in the tag memory 156B. The prefetch control module 154B is also configured to set the valid bit for the tag address to a logic true state.

Upon power up, the prefetch control module 154B can clear (e.g., set to logic false) all the validity bits associated with the tag addresses in the tag memory 156B. As data chunks are requested and received from the memory module 130 and cached to the data cache 156A, the validity bit corresponding to the tag address for each data chunk can be set to a logic true state. Thus, the tag memory 156B can be used to track which data chunks stored in the data cache 156A of the prefetch module 150 are actually representative of data stored in the memory module 130. These procedures can be tracked for both read and write operations.

When the hit logic 157B outputs a logic true signal to the prefetch control module 154B for a certain row address received from the memory controller 120, then the prefetch control module 154B can direct the data cache 156A to output a corresponding chunk of data over the “Read Data” signal path shown in FIG. 5B. The prefetch address controller 154A can also use the column address (e.g., “C_ADDR”) received from the memory controller 120 to address the multiplexer 159. Based on the column address, the multiplexer 159 is configured to output a portion of the data placed on the “Read Data” signal path. As one example, the multiplexer 159 can output one cache line of the data (e.g., 32 bytes, 64 bytes, 128 bytes) placed on the “Read Data” signal path, according to the cache line size of the system processor 110, although any suitable amount of data can be output. The memory interface 152 can then forward the data to the memory controller 120 for processing by the system processor 110.

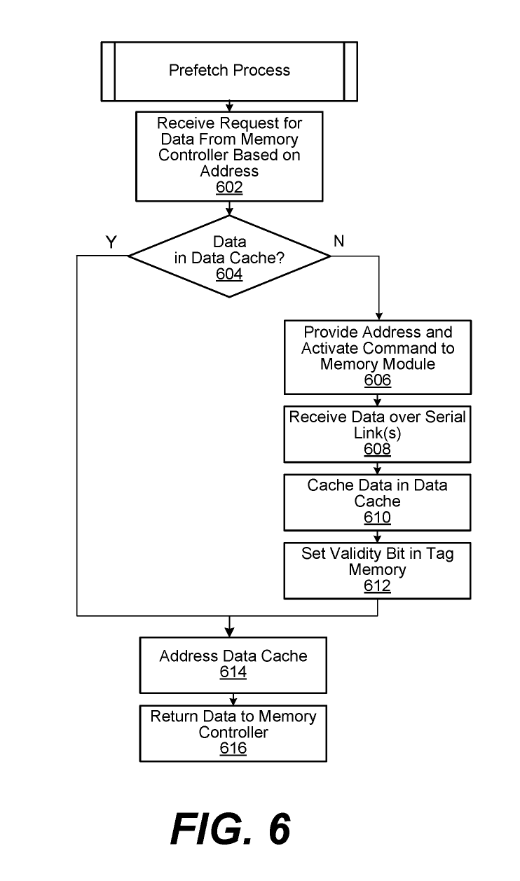

FIG. 6 illustrates an example prefetch process performed by a prefetch module according to various embodiments described herein. The process diagram shown in FIG. 6 provides one example of a sequence of steps that can be used for a prefetch process as described herein. The arrangement of the steps shown in FIG. 6 is provided by way of representative example. In other embodiments, the order of the steps can differ from that depicted. For example, an order of execution of two or more of the steps can be scrambled relative to the order shown. Also, in some cases, two or more of the steps can be performed concurrently or with partial concurrence. Further, in some cases, one or more of the steps can be skipped or omitted. Additionally, although the process is described in connection with the prefetch module 150 shown in FIG. 5B, other prefetch modules can perform the process.

At step 602, the process can include the prefetch module 150 receiving a request for data from the memory controller 120. The request can be received along with an address, and the address can specify row and column address portions. The request can be formatted according to the DFI interface protocol, for example, although other protocols or formats can be used.

At step 604, the process can include the prefetch module 150 determining whether or not the data associated with the address received at step 602 is stored in the data cache 156A on the prefetch module 150. For example, the process can include the prefetch address controller 154A of the prefetch module 150 comparing a row address received from the memory controller 120 at step 602 with a corresponding tag address in the tag memory 156B using the address comparator 157A.

The output of the address comparator 157A, which may be a logic true or false signal depending upon whether the addresses match, can be provided as a first input to the hit logic 157B. The validity bit associated with the tag address in the tag memory 156B is also provided as a second input to the hit logic 157B. If the addresses match and the validity bit associated with the tag address is also true, the hit logic 157B can output a logic true signal (e.g., a “hit”) to the prefetch control module 154B. In that case, there is a “hit,” meaning that the prefetch buffer 150 has previously cached the data being requested at the row address received from the memory controller 120, and the process proceeds to step 614. On the other hand, if the validity bit associated with the tag address is false, then the hit logic 157B can output a logic false signal to the prefetch control module 154B. In that case, there is no “hit,” meaning that the prefetch buffer 150 has not previously cached the data being requested at the row address received from the memory controller 120, and the process proceeds to step 606.

If the prefetch buffer 150 has not previously cached the data being requested at step 602, the process proceeds to step 606. At step 606, the process can include the prefetch control module 154B sending the appropriate activate command to open a row in each of the memory arrays of the memory devices 130A-130n according to the row address received from the memory controller 120 at step 602.

At step 608, the process can include the prefetch control module 154B coordinating the operations of the high speed serdes 158 to receive the data stored in the row buffers of each of the memory devices 130A-130n over the high speed serial link 162 as a chunk of data. The chunk of data can be temporarily placed in the read buffer 156C and, in turn, cached into the data cache 156A at a corresponding tag address stored in the tag memory 156B at step 610. At step 612, the process can also include the prefetch control module 154B setting the valid bit for the tag address associated with the chunk of data to a logic true state.

When the hit logic 157B outputs a logic true signal at step 604 (or after step 612), then the process proceeds to step 614. At step 614, the process can include the prefetch control module 154B addressing the data cache 156A to output a corresponding chunk of data over the “Read Data” signal path shown in FIG. 5B. The data cache 156A can be addressed based on a tag address stored in the tag memory 156B, for example, according to the row address received from the memory controller 120 at step 602. Alternatively, data cache 156A can be directly addressed based on the row address received from the memory controller 120 at step 602.

The addressing at step 614 can also be directed based on the column address received at step 602. Particularly, the prefetch address controller 154A can also use the column address received from the memory controller 120 to address the multiplexer 159 at described above with reference to FIG. 5B. Based on the column address, the multiplexer 159 can output a portion of the data placed on the “Read Data” signal path to the memory interface 152 in response to the request received at step 602. As one example, the multiplexer 159 can output one cache line of the data (e.g., 32 bytes, 64 bytes, 128 bytes) placed on the “Read Data” signal path, according to the cache line size of the system processor 110, although any suitable amount of data can be output. The memory interface 152 can then return the data to the memory controller 120 for processing by the system processor 110 at step 616.

The elements shown in FIGS. 1-3, 4A, 4B, 5A, and 5B, including the prefetch module 150, can be embodied in hardware, software, or a combination of hardware and software. If embodied in software, each element can represent a module of code or a portion of code that includes program instructions to implement the specified logical function(s). The program instructions can be embodied in the form of source code that includes human-readable statements written in a programming language or machine code that includes machine instructions recognizable by a suitable execution system, such as a processor in a computer system or other system. If embodied in hardware, each element can represent a circuit or a number of interconnected circuits that implement the specified logical function(s).

The prefetch module 150 can include one more processing circuits and memories and can be embodied in the form of hardware, as software components that are executable by hardware, or as a combination of software and hardware. If embodied as hardware, the components described herein can be implemented as a circuit or state machine that employs any suitable hardware technology. The hardware can include one or more processing circuits, discrete logic circuits having logic gates for implementing various logic functions, application specific integrated circuits (ASICs) having appropriate logic gates, and/or programmable logic devices (e.g., field-programmable gate array (FPGAs).

Also, one or more or more of the components described herein that includes software or program instructions can be embodied in a non-transitory computer-readable medium for use by or in connection with an instruction execution system such as a general purpose or application specific processor or processing circuit. The computer-readable medium can contain and store the software or program instructions for execution by the instruction execution system.

The computer-readable medium can include physical media, such as, magnetic, optical, semiconductor, or other suitable media or devices. Examples of a suitable computer-readable media include, but are not limited to, solid-state drives, magnetic drives, flash memory, and related memory devices. The processing circuitry can retrieve the software or program instructions from the computer-readable medium and, based on execution of the program instructions, be configured or directed to perform any of the functions described herein.

Although embodiments have been described herein in detail, the descriptions are by way of example. The features of the embodiments described herein are representative and, in alternative embodiments, certain features and elements can be added or omitted. Additionally, modifications to aspects of the embodiments described herein can be made by those skilled in the art without departing from the spirit and scope of the present invention defined in the following claims, the scope of which are to be accorded the broadest interpretation so as to encompass modifications and equivalent structures.

Therefore, the following is claimed:

1. A prefetch module, comprising:
a serdes configured to serialize data for transmission to a memory module and to deserialize data received from row buffers of a plurality of memory devices on the memory module;
a data cache configured to store data received over the serdes;
a tag memory configured to store at least one tag address and validity bit associated with data stored in the data cache; and
a prefetch control module configured to coordinate data exchange between a memory controller and the memory module over the serdes based on interface signals defined by an interface protocol of the memory controller.

2. The prefetch module of claim 1, wherein the serdes is communicatively coupled to the memory module by at least one serial communications link.

3. The prefetch module of claim 1, wherein the serdes is communicatively coupled to the memory module by a respective serial communications link to each of the plurality of memory devices on the memory module.

4. The prefetch module of claim 1, wherein:
the memory module comprises a dual in-line memory module (DIMM);
the plurality of memory devices on the memory module comprise a plurality of double data rate (DDR) dynamic random access memory (DRAM) devices.

5. The prefetch module of claim 1, wherein the prefetch control module is further configured to:
receive, from the memory controller, a request for data associated with an address;
determine whether the data cache contains the data associated with the address based on a comparison of the address with the at least one tag address and the validity bit.

6. The prefetch module of claim 5, wherein, based on a determination that the data cache does not contain the data associated with the address, the prefetch control module is further configured to:
open a row of memory in at least one of the plurality of memory devices on the memory module based on an activate command, the row of memory being associated with a plurality of columns of memory;
receive, by the serdes, data from the plurality of columns of memory over a serial communications link in response to the activate command; and
cache the data from the plurality of columns of memory in the data cache.

7. The prefetch module of claim 6, wherein the prefetch control module is further configured to return, from the data cache, the data associated with the address received from the memory controller to the memory controller.

8. The prefetch module of claim 5, wherein, based on a determination that the data cache does not contain the data associated with the address, the prefetch control module is further configured to:
open a row of memory in each of the plurality of memory devices on the memory module based on an activate command, each row of memory being associated with a plurality of columns of memory in a respective one of the plurality of memory devices;
receive, by the serdes, data from the plurality of columns of memory in each of the plurality of memory devices over a respective serial communications link in response to the activate command; and
cache the data from the plurality of columns of memory in each of the plurality of memory devices in the data cache.

9. A method to prefetch data, comprising:
receiving, from a memory controller, a request for data associated with an address;
determining whether a data cache contains the data associated with the address based on a comparison of the address with a tag address stored in a tag memory and a validity bit for the tag address stored in the tag memory;
based on a determination that the data cache does not contain the data associated with the address, opening a row of memory in at least one of a plurality of memory devices on a memory module based on the address, the row of memory being associated with a plurality of columns of memory;
receiving, by a serdes, data from the plurality of columns of memory;
caching the data from the plurality of columns of memory in a data cache; and
returning the data from the data cache to the memory controller.

10. The method of claim 9, wherein the serdes is communicatively coupled to the memory module by at least one serial communications link.

11. The method of claim 9, wherein the serdes is communicatively coupled to the memory module by a respective serial communications link to each of the plurality of memory devices on the memory module.

12. The method of claim 9, wherein:
the memory module comprises a dual in-line memory module (DIMM);
the plurality of memory devices on the memory module comprise a plurality of double data rate (DDR) dynamic random access memory (DRAM) devices.

13. The method of claim 9, further comprising, based on a determination that the data cache does contain the data associated with the address, returning the data from the data cache to the memory controller.

14. The method of claim 9, further comprising:
opening a row of memory in each of the plurality of memory devices on the memory module based on the address, each row of memory being associated with a plurality of columns of memory in a respective one of the plurality of memory devices; and
receiving data from the plurality of columns of memory of each of the plurality of memory devices over a respective serial communications link.

15. The method of claim 9, further comprising, after caching the data from the plurality of columns of memory in the data cache, setting the validity bit for the tag address stored in the tag memory.

16. The method of claim 9, wherein returning the data from the data cache to the memory controller comprises:
outputting a chunk of data from the data cache to a multiplexer based on a row address received from the memory controller; and
outputting a cache line of the chunk of data from the data cache from the multiplexer based on a column address received from the memory controller.

17. A prefetch module, comprising:
a serdes configured to serialize data for transmission to a memory device and to deserialize data received from a row buffer of the memory devices;
a data cache configured to store data received over the serdes; and
a prefetch control module configured to coordinate data exchange between a memory controller and the memory device over the serdes based on interface signals defined by an interface protocol of the memory controller.

18. The prefetch module of claim 17, wherein the serdes is communicatively coupled to the memory device by at least one serial communications link.

19. The prefetch module of claim 17, wherein the memory device comprises a plurality of memory devices and the serdes is communicatively coupled to the plurality of memory devices by a respective serial communications link to each of the plurality of memory devices.

20. The prefetch module of claim 17, wherein:
the memory device is on a memory module;
the memory module comprises a dual in-line memory module (DIMM); and
the memory device on the memory module comprises a double data rate (DDR) dynamic random access memory (DRAM) device.
